(19) United States
(12) Patent Application Publication
(10) Pub. No.: US 2006/0222338 A1
(43) Pub. Date: Oct. 5, 2006

(54) Recording/playback control device, contents management method and recording/playback apparatus

(76) Inventors: Masato Kihara, Kyoto (JP); Yuji Tanikawa, Osaka (JP); Satoshi Yabuta, Osaka (JP)

Correspondence Address: MCDERMOTT WILL & EMERY LLP, 600 13TH STREET, N.W., WASHINGTON, DC, 20005-3096, US

(21) Appl. No.: 11/393,867

(22) Filed: Mar. 31, 2006

(30) Foreign Application Priority Data
Mar. 31, 2005 (JP) 2005-102471

(51) Int. Cl. H04N 7/00; H04N 5/91

(52) U.S. Cl. 386/95

(57) ABSTRACT

A decision section decides whether or not contents recorded on a HDD satisfy a predetermined condition based on contents management information indicating an attribute of the contents and an operation exerted on the contents. If contents satisfying the condition have not been compressed by a contents compress processing section, the contents are compressed by the contents compress processing section. If having been compressed, the contents are deleted by a contents delete processing section.

### CROSS-REFERENCE TO RELATED APPLICATIONS

This application claims priority under 35 U.S.C. § 119 on Patent Application No. 2005-102471 filed in Japan on Mar. 31, 2005, the entire contents of which are hereby incorporated by reference.

### BACKGROUND OF THE INVENTION

The present invention relates to a recording/playback control device for managing whether or not contents recorded on a recording medium such as a hard disk and a rewritable optical disk should be stored, a contents management method for managing whether or not contents should be stored, and a recording/playback apparatus using such a recording/playback control device.

In recent years, as AV equipment for recording/playing back video data, audio data and the like, recording/playback apparatuses that not only support a recording medium such as a magnetic tape, an optical disk and a memory card but also are provided with a large-capacity hard disk have been developed.

In particular, in the case of DVD recorder equipment, for example, such a recording/playback apparatus is provided with a large-capacity hard disk to enable storage of a large amount of contents (program data) on the hard disk. This makes it unnecessary to prepare many recording media such as magnetic tapes and optical disks as conventionally done, and thus provides great convenience to the user in the management of recording and contents recorded.

However, as the capacity of the hard disk becomes greater, the user finds more difficulty in grasping the contents of all program data recorded on the large-capacity hard disk (for example, data of several hundreds of hours can be recorded on a disk of several hundreds of gigabytes).

Due to the failure of grasping all program data recorded on the large-capacity hard disk, unnecessary contents may be unintentionally accumulated on the hard disk. Therefore, when the hard disk has become full of data, the user must find out unnecessary program data from a huge amount of recorded program data and delete them. This is greatly burdensome for the user.

To overcome the above problem, some conventional recording/playback apparatuses automatically delete contents satisfying a condition such as that the program data is old or that the program data has been played back many times, for example, to thereby improve the user's convenience (see Japanese Laid-Open Patent Publication No. 2001-283501, for example).

However, the deletion of contents only because the program data is old or that the program data has been played back many times may possibly lead to deletion of contents necessary for the user.

### SUMMARY OF THE INVENTION

An object of the present invention is providing a recording/playback control device, a recording/playback apparatus and a contents management method, capable of securing free space on a recording medium easily while reducing the risk of unintentionally deleting contents necessary for the user.

To attain the above object, the present invention is directed to a recording/playback control device for performing recording/playback of a plurality of units of contents on/from a recording medium, including:

management condition-using decision means for deciding, based on contents management information indicating an attribute of contents, an operation exerted on the entire of one unit of contents and an operation exerted on a portion of one unit of contents, whether or not the contents satisfy a predetermined contents management condition; and

recording region securing means for performing processing of securing a recording region of the recording medium by compressing the entire contents or a portion of contents decided as satisfying the contents management condition.

With the above configuration, contents are compressed based on an operation performed for the contents to thereby secure free space on the recording medium.

In an embodiment of the invention, the recording region securing means is adapted to delete the entire contents or a portion of contents satisfying the contents management condition if the contents satisfying the contents management condition have already been compressed by the recording region securing means.

With the above configuration, contents satisfying a contents management condition are first compressed. Therefore, the risk of unintentionally deleting program data necessary for the user can be reduced.

Alternatively, the present invention is directed to a recording/playback control device for performing recording/playback of a plurality of units of contents on/from a recording medium, including:

management condition-using decision means for deciding, based on contents management information indicating an attribute of contents, an operation exerted on the entire of one unit of contents and an operation exerted on a portion of one unit of contents, whether or not the contents satisfy a predetermined contents management condition; and

recording region securing means for performing processing of securing a recording region of the recording medium by moving the contents or the portion of contents decided as satisfying the contents management condition to another recording medium.

With the above configuration, the contents are moved based on an operation performed for the contents to thereby secure free space on the recording medium.

In an embodiment of the invention, the management condition-using decision means is adapted to perform the decision when the free space of a region for recording contents on the recording medium is below a predetermined amount of space.

With the above configuration, whether or not a contents management condition is satisfied is determined according to the free space on the recording medium, and contents satisfying the contents management condition are compressed or moved.

In another embodiment of the invention, the recording/playback control device further includes contents decompression means for returning compressed contents satisfying a predetermined condition to their pre-compressed state when the free space of a region for recording contents on the recording medium exceeds a predetermined amount of space.

With the above configuration, as many units of contents as possible are stored in the playback-ready state according to the free space on the recording medium.

In yet another embodiment of the invention, the contents management information includes information indicating whether or not the contents have been copied to another recording medium, and the recording region securing means is adapted to perform the processing of securing a recording region for the original contents when the contents have been copied to another recording medium.

With the above configuration, when contents have been copied to another recording medium, the original contents are compressed or moved. Therefore, the risk of deleting program data necessary for the user can be reduced.

In yet another embodiment of the invention, the contents management information includes information indicating the latest playback date/time of the contents, and

the recording region securing means is adapted to perform the processing of securing a recording region for contents for which a predetermined time period has passed from the latest playback date/time.

In yet another embodiment of the invention, the information indicating the latest playback date/time is updated when playback has been made for a predetermined time or longer.

With the above configuration, contents are compressed or moved according to the lapse time from the latest playback date/time, to thereby secure free space on the recording medium.

In yet another embodiment of the invention, the contents management information includes information indicating whether a portion or the entire of contents has been played back, and, if a portion of contents has been played back, information indicating the playback date/time of the played-back portion, the segment played back and the number of portions in which the contents have been played back separately,

the management condition-using decision means is adapted to decide whether or not the contents have a portion satisfying the contents management condition, and

the recording region securing means is adapted to perform the processing of securing a recording region for the portion of the contents satisfying the contents management condition.

With the above configuration, contents are compressed or moved according to whether or not a portion of the contents satisfies a predetermined condition, to thereby secure free space on the recording medium.

In yet another embodiment of the invention, the contents management information includes information indicating for which portion of the contents rapid playback has been made, and

the recording region securing means is adapted to perform the processing of securing a recording region for the portion for which rapid playback has been made.

With the above configuration, contents are compressed or moved for the segment for which rapid playback has been made, to thereby secure free space on the recording medium.

In yet another embodiment of the invention, the contents management information includes information indicating for which portion of the contents and how many times rapid playback has been made, and

the recording region securing means is adapted to perform the processing of securing a recording region for the portion for which rapid playback has been made for a predetermined number of times or more.

With the above configuration, contents are compressed or moved for the segment for which rapid playback has been made for a predetermined number of times or more, to thereby secure free space on the recording medium.

In yet another embodiment of the invention, the contents management information includes information that allows for identification of which portion of the contents is a main body of the contents, and

the recording region securing means is adapted to perform the processing of securing a recording region for a portion for which rapid playback has been made, irrespective of the number of times of rapid playback for the portion, if the portion is a portion other than the main body of the contents.

With the above configuration, contents are compressed or moved according to the number of times of rapid playback for the contents and whether or not the portion subjected to rapid playback belongs to the main body of the contents, to thereby secure free space on the recording medium. Therefore, the risk of deleting program data necessary for the user is reduced.

In yet another embodiment of the invention, when being instructed to copy the contents to another recording medium, the recording region securing means is adapted to move the contents to the another recording medium, irrespective of the instruction of copying, if the instruction is to copy the contents in the same image format and at the same bit rate as the original contents, or copy the contents as instructed if the instruction is to copy the contents in a different image format from or at a lower bit rate than the original contents.

With the above configuration, contents are compressed or moved when the contents are dubbed to another recording medium in the same format and at the same bit rate, to thereby secure free space on the recording medium. Therefore, the risk of deleting program data necessary for the user is reduced.

### BRIEF DESCRIPTION OF THE DRAWINGS

FIG. 1 is a block diagram of a recording/playback apparatus of Embodiment 1 of the present invention.

FIG. 2 is a flowchart showing an operation of updating management information when contents have been played back.

FIG. 3 is a flowchart showing an operation of updating management information when contents have been subjected to rapid playback.

FIG. 4 is a flowchart showing an operation of updating management information when contents have been dubbed.

FIG. 5 is a flowchart showing an operation of setting a threshold.

FIG. 6 is a flowchart showing an operation of contents management done for contents dubbed to another recording medium.

FIG. 7 is a flowchart showing an operation of contents management done based on the contents latest view date/time.

FIG. 8 is a flowchart showing an operation of contents management done based on the number of times of rapid playback for contents.

FIG. 9 is a flowchart showing an operation of contents management done when contents are dubbed to another recording medium.

FIG. 10 is a flowchart showing an operation done when compressed contents are returned to their pre-compressed state.

### DESCRIPTION OF THE PREFERRED EMBODIMENTS

Hereinafter, as an embodiment of the present invention, a recording/playback apparatus that decides whether or not contents recorded on a recording medium such as a hard disk or a rewritable DVD (DVD±R, DVD±RW, DVD-RAM) should be stored to perform contents management will be described with reference to the accompanying drawings.

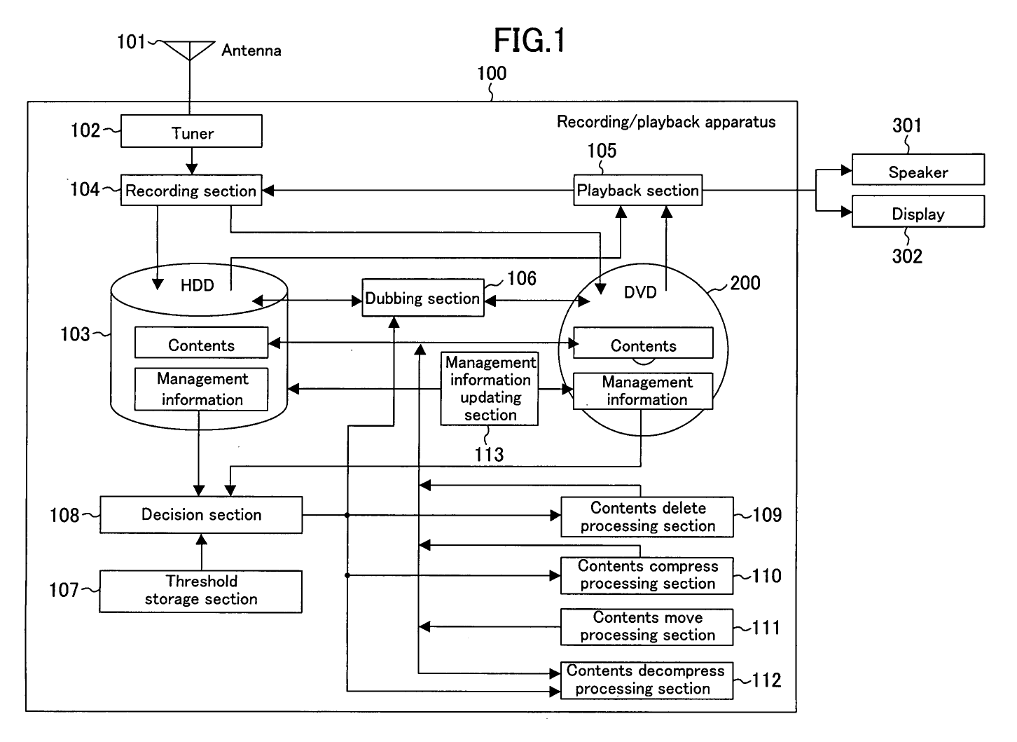

FIG. 1 is a block diagram of a recording/playback apparatus 100 of an embodiment of the present invention.

Referring to FIG. 1, the recording/playback apparatus 100 includes an antenna 101, a tuner 102, a HDD 103, a recording section 104, a playback section 105, a dubbing section 106, a threshold storage section 107, a decision section 108, a contents delete processing section 109, a contents compress processing section 110, a contents move processing section 111, a contents decompress processing section 112 and a management information updating section 113.

The antenna 101 is adapted to receive a radio wave from a broadcast station and outputs a signal based on the received radio wave to the tuner 102.

The tuner 102 is adapted to convert the signal from the antenna 101 to a form recordable on a recording medium.

The HDD 103 is a recording medium such as a hard disk drive, adapted to allow for recording thereon of a plurality of units of contents such as broadcast data and management information on the stored contents.

The management information refers to information including attribute information of contents such as the date/time of recording of the contents and the genre of the contents and information indicating operations done for the contents such as when the contents have been played back.

Table 1 shows, by way of example, contents and management information on the contents recorded on the HDD 103. In the example shown in Table 1, movie programs A1 and A2, music programs B1 and B2, and news programs C1 and C2 are recorded on the HDD 103.

TABLE 1

| | | Management information of contents | | | |
|---|---|---|---|---|---|
| | | Externally | Latest view | | Record |
| | Contents | stored | Date/time | Rapid playback | date/time |
| A1 | Movie program | Same format/ | 9/28/04 | — | 8/12/04 |
| | | Same bit rate | 21:00 | | 21:00 |
| A2 | Movie program | — | 7/28/04 | — | 7/12/04 |
| | | | 21:00 | | 21:00 |
| B1 | Music program | — | 8/14/04 | 21:00-21:20 | 6/5/04 |
| | | | 22:00 | (twice, main) | 21:00 |
| | | | | 21:45-21:46 | |
| | | | | (once, others) | |
| B2 | Music program | — | 9/9/04 | 21:05-21:15 | 6/12/04 |
| | | | 22:00 | (3 times, main) | 21:00 |
| | | | | 21:45-21:46 | |
| | | | | (twice, others) | |
| C1 | News program | — | 4/10/04 | 21:00-22:00 | 4/10/04 |
| | | | 23:00 | (once, main & others) | 21:00 |
| C2 | News program | — | 4/13/04 | 21:00-22:00 | 4/12/04 |
| | | | 23:00 | (once, main & others) | 21:00 |

The recording section 104 is adapted to record contents received from the tuner 102 and management information on the contents on the HDD 103.

The playback section 105 is adapted to decode contents recorded on the HDD 103 and contents recorded on a rewritable DVD 200 and output the decoded data.

The dubbing section 106 is adapted to copy contents between the HDD 103 and the rewritable DVD 200.

The dubbing section 106 copies only copy-free contents. Copy-restricted (copy-once or no-more-copy) contents are moved, not copied, to achieve dubbing.

The threshold storage section 107 is adapted to store thresholds used for decision on whether or not contents should be compressed or deleted. Specifically, the following five thresholds (thresholds 1 to 5) are stored.

Threshold 1 is a threshold indicating the free space (lower-limit value) on a recording medium as a criterion for decision on whether or not contents should be compressed or deleted. Threshold 2 is a threshold indicating the free space (lower-limit value) on a recording medium as a criterion for decision on whether or not compressed contents should be decompressed. Threshold 3 is a threshold indicating the storage valid period of contents. Threshold 4 is a threshold indicating the minimum playback time of contents required for updating the latest view date/time included in the management information. Threshold 5 is a threshold used for deciding whether or not contents should be stored from the total number of times of rapid playback.

The thresholds 1 to 3 and 5 are used in the decision section 108, while the threshold 4 is used in the management information updating section 113. A default set value may be set for each threshold at the startup of the apparatus, or the user may set each threshold.

The decision section 108 decides whether or not contents or a portion of contents recorded on the HDD 103 and the rewritable DVD 200 satisfy any of conditions ((1) to (4)) to be described later using the management information recorded on the HDD 103 and the rewritable DVD 200 and the thresholds stored in the threshold storage section 107. If contents satisfying any of the conditions or a portion of contents satisfying any of the conditions have been compressed, the decision section 108 instructs the contents delete processing section 109 to delete the contents or the portion of contents satisfying the condition. If the contents or the portion of contents have not been compressed, the decision section 108 instructs the contents compress processing section 110 to compress the contents or the portion of contents satisfying the condition. The conditions (1) to (4) are as follows.

Condition (1): the contents have been copied (dubbed) to a recording medium other than the recording medium in which free space is to be secured.

Condition (2): a predetermined time period (threshold 3) has passed from the latest view date/time of the contents. Note however that contents of which only a portion has been played back should not be deleted, because, in some cases, the user may view the entire contents at a time, or in other cases, may view the contents in a plurality of portions separately.

Condition (3): rapid playback has been made for portions other than the main body of the contents (for example, commercials).

Condition (4): the number of times of rapid playback for the main body of the contents is greater than a predetermined number of times (threshold 5).

Also, the decision section 108 is adapted to instruct the contents move processing section 111 to move contents if the contents are to be dubbed in the same format and at the same bit rate, while instructing the dubbing section 106 to copy contents if at least either the format or the bit rate is different.

The decision section 108 is also adapted to decompress compressed contents that satisfy a predetermined condition to resume their pre-compressed state if the HDD 103 has sufficient free space (specifically, if the free space exceeds the threshold 2).

The contents delete processing section 109 is adapted to delete the contents specified by the decision section 108 from the HDD 103.

The contents compress processing section 110 is adapted to compress the contents specified by the decision section 108. Examples of the compression method include a compression method such as zip often used in personal computers and the like, for example, a method in which contents are re-encoded at a reduced bit rate and re-stored, and a method in which contents are converted to a format with a high compression rate. The compression method is however not limited to these as long as free space can be secured on the HDD 103.

The contents move processing section 111 is adapted to move the contents between the HDD 103 and the rewritable DVD 200.

The contents decompress processing section 112 is adapted to decompress the contents compressed by the contents compress processing section 110 to resume their pre-compressed state, according to an instruction from the decision section 108.

The management information updating section 113 is adapted to update management information when any of recording, deletion, playback and dubbing of the contents has been executed.

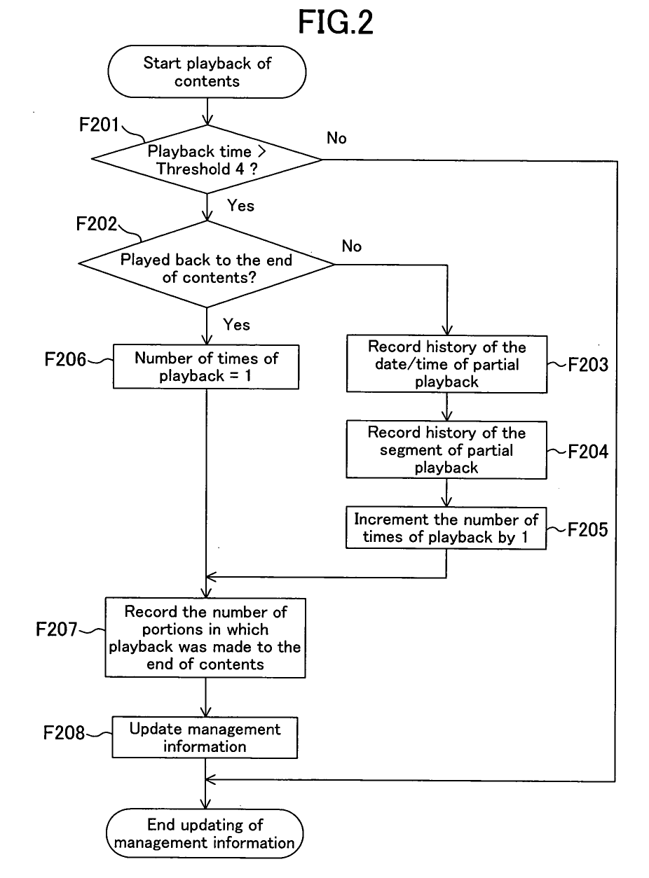

Specifically, when the contents are played back at a normal playback speed, the management information updating section 113 updates the management information by executing the processing shown in the flowchart of FIG. 2.

First, the management information updating section 113 checks whether or not the contents have been played back for a longer time than the time indicated by the threshold 4 (step F201). For example, the user may play back only a head portion of the contents to check the contents. This step is performed to ensure not to regard such an operation as viewing of the contents.

If the playback time is longer than the time indicated by the threshold 4, whether a portion or the entire of the contents has been played back is decided (step F202). If the entire contents have been played back, the management information (the number of times of playback) corresponding to the contents is updated (steps F206 to F208).

If a portion of the contents has been played back, the management information (information on the played-back segment and the number of times of playback of the segment) corresponding to the contents is updated based on the date/time of playback of the portion and the played-back segment (steps F203 to F205).

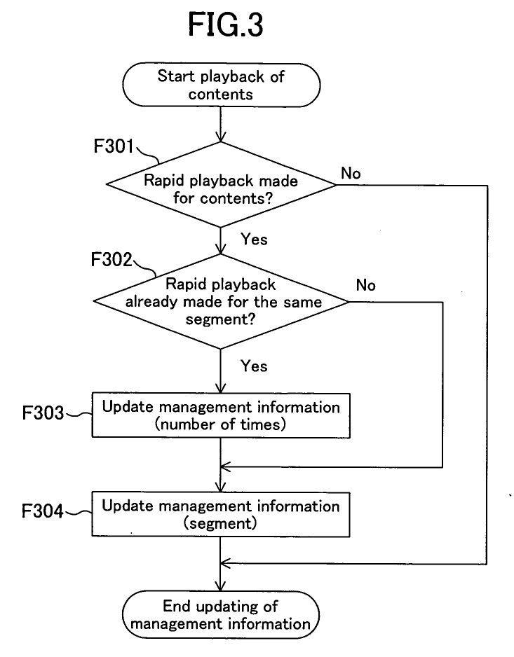

When rapid playback has been made for the contents, the management information updating section 113 updates the management information by executing the processing shown in the flowchart of FIG. 3.

Upon start of playback of the contents, the management information updating section 113 first decides whether or not rapid playback has been made for the contents (step F301). If rapid playback has been made, whether or not the segment subjected to the rapid playback this time has already been subjected to rapid playback is determined (step F302). If the segment has already been subjected to rapid playback, the number of times of playback for the segment is updated (step F303), and also the information on the segment is updated (step F304). If the rapid playback is the first one for the segment, information on the segment is newly recorded (step F304).

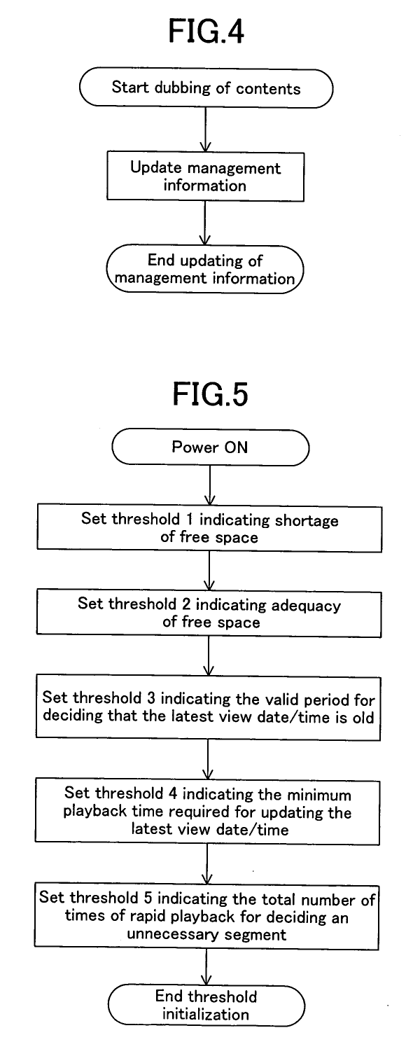

The management information is also updated when the contents have been dubbed (see the flowchart of FIG. 4).

The rewritable DVD 200, which is a rewritable recording medium such as DVD±R, DVD±RW, DVD-RAM, is adapted to record a plurality of units of contents such as broadcast data and the management information described above.

A speaker 301 is adapted to output an audio signal included in the contents decoded by the playback section 105.

A display 302 is adapted to output a video signal included in the contents decoded by the playback section 105.

The operation of the recording/playback apparatus 100 configured as described above will be described taking as an example the case that the contents shown in Table 1 are stored on the HDD 103, for example.

When the recording/playback apparatus 100 is powered on, the thresholds 1 to 5 are set in the threshold storage section 107 (see the flowchart of FIG. 5).

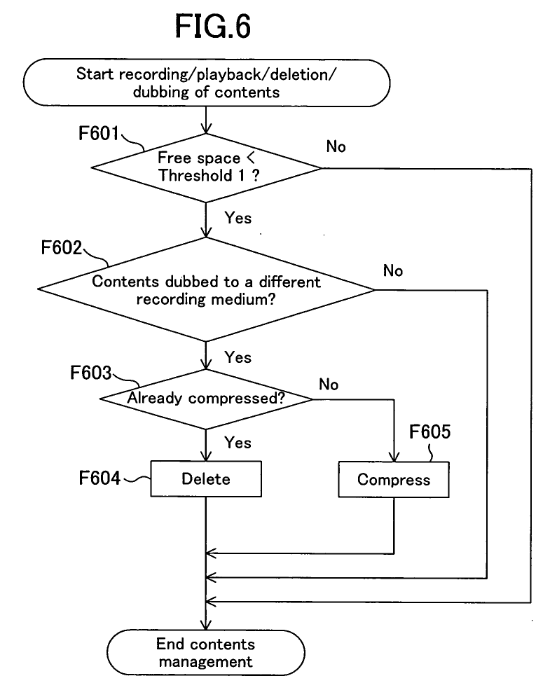

If the free space on the HDD 103 is below the threshold 1 when the user gives an instruction of recording and the like, the decision section 108 issues an instruction to delete contents and the like based on the condition (1). Specifically, the processing shown in FIG. 6 is executed.

First, the decision section 108 decides whether or not the free space on the HDD 103 is below the threshold 1 (step F601).

If the free space is below the threshold 1, whether or not any contents have been dubbed (externally stored) on a recording medium other than the HDD 103 is decided using the management information (step F602). If contents have been dubbed, whether or not the contents have been compressed is decided (step F603). If compressed, the contents are deleted by the contents delete processing section 109 (step F604). If not compressed, the contents are compressed by the contents compress processing section 110 (step F605).

In the example of Table 1, the movie program A1 has been dubbed (externally stored) on a recording medium other than the HDD 103. Therefore, the decision section 108 decides whether or not A1 has been compressed. The decision section 108 instructs the contents delete processing section 109 to delete A1 if A1 has been compressed, or instructs the contents compress processing section 110 to compress A1 if A1 has not been compressed. In this processing, the movie program A2 is kept stored on the HDD 103 because it is not stored externally although being older in the latest view date/time than A1. In this way, occurrence of an event that A2 may have been deleted unintentionally when the user attempts to view A2 again can be avoided.

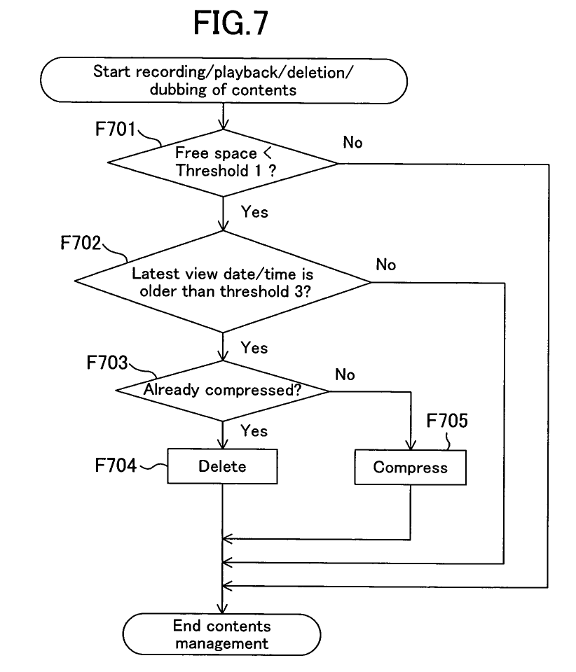

Also, the decision section 108 issues an instruction to delete contents and the like based on the condition (2) if the free space on the HDD 103 is below the threshold 1. Specifically, the processing shown in FIG. 7 is executed.

First, if the free space on the HDD 103 is below the threshold 1 (step F701), the decision section 108 decides whether or not the threshold 3 of the valid period (for example, 6 months) from the latest view date/time of any contents has passed from the management information (step F702). If the valid period (threshold 3) from the latest view date/time of contents has passed, whether or not the contents have been compressed is decided (step F703). If compressed, the contents are deleted by the contents delete processing section 109 (step F704). If not compressed, the contents are compressed by the contents compress processing section 110 (step F705).

In the example of Table 1, the movie program A2 will be compressed if the valid period (threshold 3) from the latest view date/time of A2 has passed and A2 has not been compressed.

When the free space on the HDD 103 becomes short again, for example, the decision section 108 will make the decision based on the condition (2). If the latest view date/time of A2 has not been updated at that time, the program A2, which has already been compressed, will be deleted in this case.

The threshold 3 should desirably be changed according to the genre of the contents. The reason is that it is desirable for the user to set the valid period longer for a genre such as movies that is high in the possibility of being viewed again after a lapse of time, while a genre such as news that is low in the possibility of being viewed again and places importance on newness of the contents may have a short valid period.

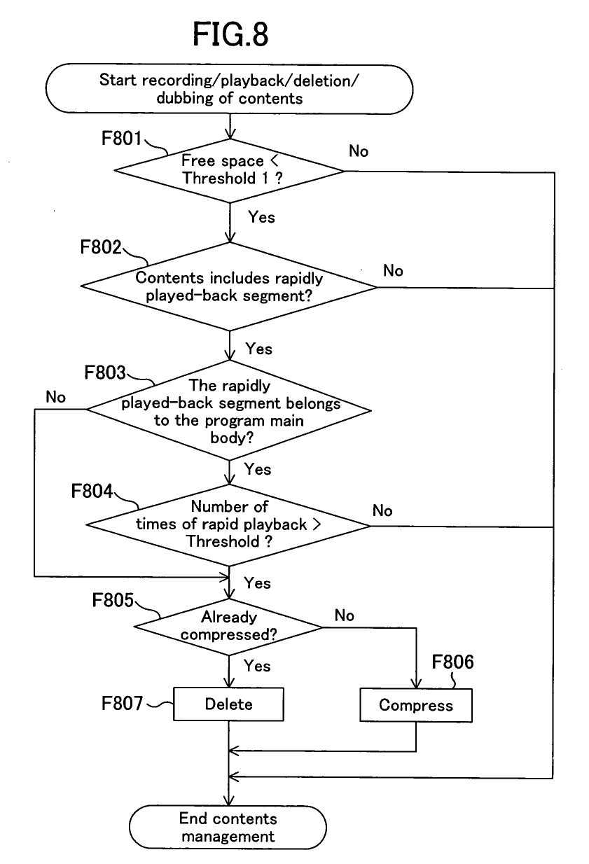

Moreover, the decision section 108 issues an instruction to delete contents and the like based on the conditions (3) and (4) if the free space on the HDD 103 is below the threshold 1. Specifically, the processing shown in FIG. 8 is executed.

If the free space on the HDD 103 is below the threshold 1 (step F801), the decision section 108 decides whether or not any contents have a portion subjected to rapid playback from the management information (step F802). If a rapidly played-back portion exists, whether or not the rapidly played-back portion belongs to the main body of a program is decided (step F803). If the rapidly played-back portion belongs to the main body of the program, whether the number of times of rapid playback is larger than the threshold 5 is determined (step F804). If the number of times of rapid playback is larger than the threshold 5, the contents are compressed or deleted. If the rapidly played-back portion does not belong to the main body of the program, the contents are compressed or deleted irrespective of the number of times of rapid playback.

For example, assume that the value of the threshold 5 is “2”. In the music program B 1 in the example of Table 1, the portion of the program main body recorded at 21:10 to 21:20 has been rapidly played back twice. In the music program B2, the portion of the program main body recorded at 21:05 to 21:15 has been rapidly played back twice. These portions are therefore compressed or deleted.

The portion of B1 recorded at 21:45 to 21:46 and the portion of B2 recorded at 21:45 to 21:46 are portions outside the respective program main bodies (for example, commercials). These portions are therefore compressed or deleted irrespective of the number of times of rapid playback. The news programs C1 and C2 are also compressed or deleted in the same manner.

The threshold 5 should also desirably be changed according to the genre of the contents. For example, news programs can be decided as unnecessary once they are rapidly played back. As for contents of the other genres (for example, music, dramas, etc.), however, since it is difficult to decide whether or not the contents are necessary, the threshold 5 should desirably be set at 2 or more.

As described above, even contents of which the time period from the latest view date/time is shorter than the threshold 3, the contents may be deleted or compressed according to the number of times of rapid playback.

Accordingly, contents rapidly played back for a plurality of times because an artist of less interest for the user appears in the contents, for example, are subjected to deletion and the like.

Also, when rapid playback is made for contents externally stored and contents considered undesirable if being kept on the HDD 103 beyond the valid period from the latest view date/time (for example, news programs), such contents are deleted or compressed, to secure space on the HDD 103.

Information other than the program main body of contents (for example, commercials) rapidly played back is deleted or compressed irrespective of the number of times of rapid playback. This makes it easier to secure space on the HDD 103.

The recording/playback apparatus 100 also performs contents management at the dubbing (copying) of contents recorded on the HDD 103 to another recording medium.

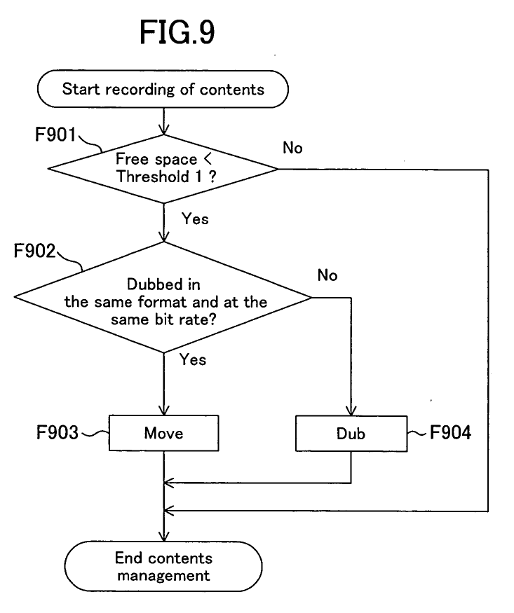

As shown in the flowchart of FIG. 9, if the free space on the HDD 103 is below the threshold 1 (step F901), the decision section 108 decides whether or not the contents are to be dubbed in the same format and at the same bit rate (step F902). If contents are to be dubbed in the same format and at the same bit rate, the decision section 108 instructs the content move processing section 111 to move the contents to secure free space on the HDD 103 (step F903).

If the contents are to be dubbed in a different format, or in the same format but at a low bit rate, the contents are not moved by the contents move processing section 111, but are copied by the dubbing section 106 (step F904), from the standpoint that the original contents should desirably be kept on the HDD 103 where possible. The contents from which the copying was made will be deleted or compressed based on the conditions (1) to (4) described above.

As described above, space on the HDD 103 can be secured when contents are dubbed to another recording medium in the same format and at the same bit rate.

In the recording/playback apparatus 100, if sufficient free space is secured, any of compressed contents that satisfy a predetermined condition may be decompressed.

In this case, information should be set, as management information, so that which contents or portion of contents was decided as unnecessary most recently.

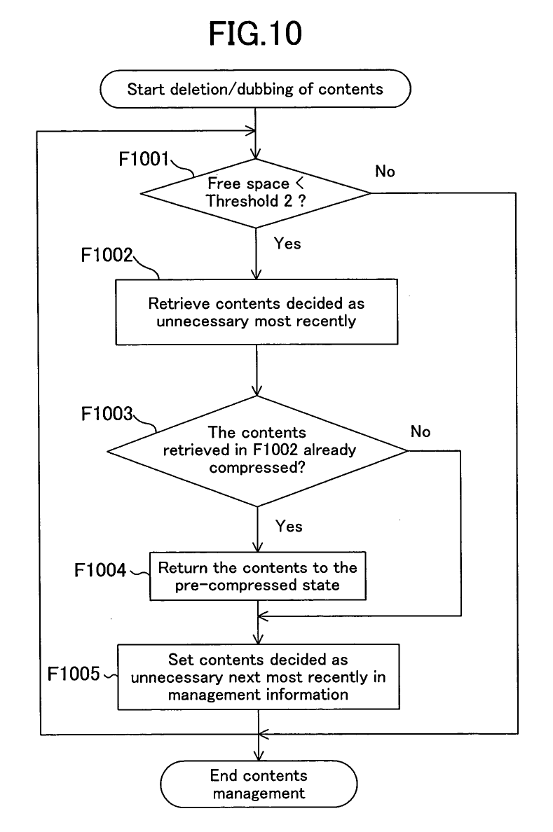

As shown in the flowchart of FIG. 10, if the free space on the HDD 103 exceeds the threshold 2 (step F1001), the decision section 108 retrieves contents or a portion of contents decided as unnecessary most recently among the contents or portions of contents decided as unnecessary (step F1002). Whether or not the retrieved contents or portion of contents has already been compressed is decided (step F1003). If already compressed, the retrieved contents are decompressed to their pre-compressed state ready for playback with the recording/playback apparatus 100 (step F1004). The management information is then reset to update the contents or the portion of contents decided as unnecessary most recently among the contents left on the HDD 103 (step F1005). By following these steps, as many units of contents as possible can be stored in the playback-ready state according to the free space on the HDD 103.

As described above, in this apparatus, the state of the operation such as rapid playback done for program data is provided as one of the criteria for deciding whether or not the program data is necessary. Thus, in the apparatus of this embodiment, whether or not program data is necessary can be decided with higher precision, and this can reduce the risk of deleting program data necessary for the user.

Also, program data is not simply deleted, but contents (or a portion of contents) decided as unnecessary are first compressed. This can also reduce the risk of deleting program data necessary for the user.

Contents management is automatically made when the used space on a recording medium becomes equal to or more than a predetermined value, for example. This can greatly reduce the operation required for securing free space that is burdensome for the user, and thus free space on a recording medium can be easily secured.

In the embodiment described above, an example of management of contents recorded on the HDD 103 was described. Substantially the same contents management may be made for contents recorded on the rewritable DVD 200.

In the embodiment described above, the contents management was made when the space on the HDD 103 was below the threshold 1. Alternatively, the contents management may be made every predetermined period or upon receipt of an instruction from the user.

Free space may be secured, not by compressing contents, but by moving contents decided as satisfying any of the conditions (1) to (4) by the decision section 108 to another recording medium (for example, the rewritable DVD 200).

As described above, the recording/playback control device, the recording/playback apparatus and the contents management method according to the present invention have an effect of being capable of easily securing free space on a recording medium while reducing the risk of unintentionally deleting contents necessary for the user, and thus are useful as a recording/playback apparatus and the like that manage whether or not contents recorded on a recording medium such as a hard disk and a rewritable optical disk should be kept stored.

While the present invention has been described in a preferred embodiment, it will be apparent to those skilled in the art that the disclosed invention may be modified in numerous ways and may assume many embodiments other than that specifically set out and described above. Accordingly, it is intended by the appended claims to cover all modifications of the invention which fall within the true spirit and scope of the invention.

What is claimed is:

1. A recording/playback control device for performing recording/playback of a plurality of units of contents on/from a recording medium, comprising:
management condition-using decision means for deciding, based on contents management information indicating an attribute of contents, an operation exerted on the entire of one unit of contents and an operation exerted on a portion of one unit of contents, whether or not the contents satisfy a predetermined contents management condition; and
recording region securing means for performing processing of securing a recording region of the recording medium by compressing the entire contents or a portion of contents decided as satisfying the contents management condition.

2. The device of claim 1, wherein the recording region securing means is adapted to delete the entire contents or a portion of contents satisfying the contents management condition if the contents satisfying the contents management condition have already been compressed by the recording region securing means.

3. A recording/playback control device for performing recording/playback of a plurality of units of contents on/from a recording medium, comprising:
management condition-using decision means for deciding, based on contents management information indicating an attribute of contents, an operation exerted on the entire of one unit of contents and an operation exerted on a portion of one unit of contents, whether or not the contents satisfy a predetermined contents management condition; and
recording region securing means for performing processing of securing a recording region of the recording medium by moving the contents or the portion of contents decided as satisfying the contents management condition to another recording medium.

4. The device of claim 1, wherein the management condition-using decision means is adapted to perform the decision when the free space of a region for recording contents on the recording medium is below a predetermined amount of space.

5. The device of claim 3, wherein the management condition-using decision means is adapted to perform the decision when the free space of a region for recording contents on the recording medium is below a predetermined amount of space.

6. The device of claim 1, further comprising contents decompression means for returning compressed contents satisfying a predetermined condition to their pre-compressed state when the free space of a region for recording contents on the recording medium exceeds a predetermined amount of space.

7. The device of claim 3, further comprising contents decompression means for returning compressed contents satisfying a predetermined condition to their pre-compressed state when the free space of a region for recording contents on the recording medium exceeds a predetermined amount of space.

8. The device of claim 1, wherein the contents management information includes information indicating whether or not the contents have been copied to another recording medium, and
the recording region securing means is adapted to perform the processing of securing a recording region for the original contents when the contents have been copied to another recording medium.

9. The device of claim 3, wherein the contents management information includes information indicating whether or not the contents have been copied to another recording medium, and
the recording region securing means is adapted to perform the processing of securing a recording region for the original contents when the contents have been copied to another recording medium.

10. The device of claim 1, wherein the contents management information includes information indicating the latest playback date/time of the contents, and
the recording region securing means is adapted to perform the processing of securing a recording region for contents for which a predetermined time period has passed from the latest playback date/time.

11. The device of claim 3, wherein the contents management information includes information indicating the latest playback date/time of the contents, and
the recording region securing means is adapted to perform the processing of securing a recording region for contents for which a predetermined time period has passed from the latest playback date/time.

12. The device of claim 10, wherein the information indicating the latest playback date/time is updated when playback has been made for a predetermined time or longer.

13. The device of claim 11, wherein the information indicating the latest playback date/time is updated when playback has been made for a predetermined time or longer.

14. The device of claim 1, wherein the contents management information includes information indicating whether a portion or the entire of contents has been played back, and, if a portion of contents has been played back, information indicating the playback date/time of the played-back portion, the segment played back and the number of portions in which the contents have been played back separately,
the management condition-using decision means is adapted to decide whether or not the contents have a portion satisfying the contents management condition, and
the recording region securing means is adapted to perform the processing of securing a recording region for the portion of the contents satisfying the contents management condition.

15. The device of claim 3, wherein the contents management information includes information indicating whether a portion or the entire of contents has been played back, and, if a portion of contents has been played back, information indicating the playback date/time of the played-back portion, the segment played back and the number of portions in which the contents have been played back separately,
the management condition-using decision means is adapted to decide whether or not the contents have a portion satisfying the contents management condition, and
the recording region securing means is adapted to perform the processing of securing a recording region for the portion of the contents satisfying the contents management condition.

16. The device of claim 1, wherein the contents management information includes information indicating for which portion of the contents rapid playback has been made, and
the recording region securing means is adapted to perform the processing of securing a recording region for the portion for which rapid playback has been made.

17. The device of claim 3, wherein the contents management information includes information indicating for which portion of the contents rapid playback has been made, and
the recording region securing means is adapted to perform the processing of securing a recording region for the portion for which rapid playback has been made.

18. The device of claim 1, wherein the contents management information includes information indicating for which portion of the contents and how many times rapid playback has been made, and
the recording region securing means is adapted to perform the processing of securing a recording region for the portion for which rapid playback has been made for a predetermined number of times or more.

19. The device of claim 3, wherein the contents management information includes information indicating for which portion of the contents and how many times rapid playback has been made, and
the recording region securing means is adapted to perform the processing of securing a recording region for the portion for which rapid playback has been made for a predetermined number of times or more.

20. The device of claim 18, wherein the contents management information includes information that allows for identification of which portion of the contents is a main body of the contents, and
the recording region securing means is adapted to perform the processing of securing a recording region for a portion for which rapid playback has been made, irrespective of the number of times of rapid playback for the portion, if the portion is a portion other than the main body of the contents.

21. The device of claim 19, wherein the contents management information includes information that allows for identification of which portion of the contents is a main body of the contents, and
the recording region securing means is adapted to perform the processing of securing a recording region for a portion for which rapid playback has been made, irrespective of the number of times of rapid playback for the portion, if the portion is a portion other than the main body of the contents.

22. The device of claim 1, wherein when being instructed to copy the contents to another recording medium, the recording region securing means is adapted to move the contents to the another recording medium, irrespective of the instruction of copying, if the instruction is to copy the contents in the same image format and at the same bit rate as the original contents, or copy the contents as instructed if the instruction is to copy the contents in a different image format from or at a lower bit rate than the original contents.

23. The device of claim 3, wherein when being instructed to copy the contents to another recording medium, the recording region securing means is adapted to move the contents to the another recording medium, irrespective of the instruction of copying, if the instruction is to copy the contents in the same image format and at the same bit rate as the original contents, or copy the contents as instructed if the instruction is to copy the contents in a different image format from or at a lower bit rate than the original contents.

24. A contents management method for managing contents recorded on a recording medium, the method comprising the steps of:
deciding, based on contents management information indicating an attribute of contents, an operation exerted on the entire of one unit of contents and an operation exerted on a portion of one unit of contents, whether or not the contents satisfy a predetermined contents management condition (management condition-using decision step); and
performing processing of securing a recording region of the recording medium by compressing the entire contents or a portion of contents decided as satisfying the contents management condition by the management condition-using decision step (recording region securing step).

25. The method of claim 24, wherein the recording region securing step deletes the entire contents or a portion of contents satisfying the contents management condition if the contents satisfying the contents management condition have already been compressed in the recording region securing step.

26. A contents management method for performing recording/playback of a plurality of units of contents for a recording medium, the method comprising the steps of:
deciding, based on contents management information indicating an attribute of contents, an operation exerted on the entire of one unit of contents and an operation exerted on a portion of one unit of contents, whether or not the contents satisfy a predetermined contents management condition (management condition-using decision step); and
performing processing of securing a recording region of the recording medium by moving the contents or a portion of contents decided as satisfying the contents management condition in the management condition-using decision step to another recording medium (recording region securing step).

27. The method of claim 24, wherein the management condition-using decision step performs the decision when the free space of a region for recording contents on the recording medium is below a predetermined amount of space.

28. The method of claim 26, wherein the management condition-using decision step performs the decision when the free space of a region for recording contents on the recording medium is below a predetermined amount of space.

29. The method of claim 24, further comprising the step of returning compressed contents satisfying a predetermined condition to their pre-compressed state when the free space of a region for recording contents on the recording medium exceeds a predetermined amount of space (contents decompression step).

30. The method of claim 26, further comprising the step of returning compressed contents satisfying a predetermined condition to a pre-compressed state when the free space of a region for recording contents on the recording medium exceeds a predetermined amount of space (contents decompression step).

31. The method of claim 24, wherein the contents management information includes information indicating whether or not the contents have been copied to another recording medium, and
the recording region securing step performs the processing of securing a recording region for the original contents when the contents have been copied to another recording medium.

32. The method of claim 26, wherein the contents management information includes information indicating whether or not the contents have been copied to another recording medium, and
the recording region securing step performs the processing of securing a recording region for the original contents when the contents have been copied to another recording medium.

33. The method of claim 24, wherein the contents management information includes information indicating the latest playback date/time of the contents, and
the recording region securing step performs the processing of securing a recording region for contents for which a predetermined time period has passed from the latest playback date/time.

34. The method of claim 26, wherein the contents management information includes information indicating the latest playback date/time of the contents, and
the recording region securing step performs the processing of securing a recording region for contents for which a predetermined time period has passed from the latest playback date/time.

35. The method of claim 33, wherein the information indicating the latest playback date/time is updated when playback has been made for a predetermined time or longer.

36. The method of claim 34, wherein the information indicating the latest playback date/time is updated when playback has been made for a predetermined time or longer.

37. The method of claim 24, wherein the contents management information includes information indicating whether a portion or the entire of contents has been played back, and, if a portion of contents has been played back, information indicating the playback date/time of the played-back portion, the segment of the contents played back and the number of portions in which the contents have been played back separately,
the management condition-using decision step decides whether or not the contents have a portion satisfying the contents management condition, and
the recording region securing step performs the processing of securing a recording region for the portion of the contents satisfying the contents management condition.

38. The method of claim 26, wherein the contents management information includes information indicating whether a portion or the entire of contents has been played back, and, if a portion of contents has been played back, information indicating the playback date/time of the played-back portion, the segment of the contents played back and the number of portions in which the contents have been played back separately,
the management condition-using decision step decides whether or not the contents have a portion satisfying the contents management condition, and
the recording region securing step performs the processing of securing a recording region for the portion of the contents satisfying the contents management condition.

39. The method of claim 24, wherein the contents management information includes information indicating for which portion of the contents rapid playback has been made, and
the recording region securing step performs the processing of securing a recording region for the portion for which rapid playback has been made.

40. The method of claim 26, wherein the contents management information includes information indicating for which portion of the contents rapid playback has been made, and
the recording region securing step performs the processing of securing a recording region for the portion for which rapid playback has been made.

41. The method of claim 24, wherein the contents management information includes information indicating for which portion of the contents and how many times rapid playback has been made, and
the recording region securing step performs the processing of securing a recording region for the portion for which rapid playback has been made for a predetermined number of times or more.

42. The method of claim 26, wherein the contents management information includes information indicating for which portion of the contents and how many times rapid playback has been made, and
the recording region securing step performs the processing of securing a recording region for the portion for which rapid playback has been made for a predetermined number of times or more.

43. The method of claim 41, wherein the contents management information includes information that allows for identification of which portion of the contents is a main body of the contents, and
the recording region securing step performs the processing of securing a recording region for a portion for which rapid playback has been made, irrespective of the number of times of rapid playback for the portion, if the portion is a portion other than the main body of the contents.

44. The method of claim 42, wherein the contents management information includes information that allows for identification of which portion of the contents is a main body of the contents, and
the recording region securing step performs the processing of securing a recording region for a portion for which rapid playback has been made, irrespective of the number of times of rapid playback for the portion, if the portion is a portion other than the main body of the contents.

45. The method of claim 24, wherein in the recording region securing step, when an instruction of copying the contents to another recording medium is made, the contents are moved to the another recording medium, irrespective of the instruction of copying, if the instruction is to copy the contents in the same image format and at the same bit rate as the original contents, or the contents are copied as instructed if the instruction is to copy the contents in a different image format from or at a lower bit rate than the original contents.

46. The method of claim 26, wherein in the recording region securing step, when an instruction of copying the contents to another recording medium is made, the contents are moved to the another recording medium, irrespective of the instruction of copying, if the instruction is to copy the contents in the same image format and at the same bit rate as the original contents, or the contents are copied as instructed if the instruction is to copy the contents in a different image format from or at a lower bit rate than the original contents.

47. A recording/playback apparatus comprising the recording/playback control device of claim 1 and the recording medium.

48. A recording/playback apparatus comprising the recording/playback control device of claim 2 and the recording medium.

49. A recording/playback apparatus comprising the recording/playback control device of claim 3 and the recording medium.
